(19) United States
(12) Patent Application Publication
(10) Pub. No.: US 2007/0003317 A1
(43) Pub. Date: Jan. 4, 2007

(54) Image forming apparatus and processing unit

(75) Inventor: Sadahiro Masuda, Mishima-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: Kabushiki Kaisha Toshiba, Minato-ku (JP); Toshiba Tec Kabushiki Kaisha, Shinagawa-ku (JP)

(21) Appl. No.: 11/479,282

(22) Filed: Jun. 30, 2006

(30) Foreign Application Priority Data
Jun. 30, 2005 (JP) 2005-191967

(51) Int. Cl. G03G 15/16

(52) U.S. Cl. 399/101

(57) ABSTRACT

A working part of a cleaning unit is moved with a processing unit, when the processing unit is inserted into and removed from a main body. A driving part of the cleaning unit stays in the main body regardless of the movement of the processing unit.

### CROSS-REFERENCE TO RELATED APPLICATIONS

This application is based upon and claims the benefit of priority from prior Japanese Patent Application No. 2005-191967, filed Jun. 30, 2005, the entire contents of which are incorporated herein by reference.

### BACKGROUND OF THE INVENTION

1. Field of the Invention

The present invention relates to an image forming apparatus provided with a processing unit which can be inserted into and removed from the main body of the apparatus, and a processing unit.

2. Description of the Related Art

An image forming apparatus such as a copier has a processing unit having an image holding unit, and eliminates a developer adhered to the surface of the image holding unit by a blade held in a cleaning unit and brought into contact with the surface of the image holding unit.

A color copier has a photoconductive drum and an intermediate transfer belt as an image holding unit. The positions of the intermediate transfer belt and cleaning unit (including the contacting pressure of the blade to the intermediate transfer belt) are important to maintain good cleaning performance for the intermediate transfer belt. It is desired to configure the intermediate transfer belt and cleaning unit in one body installable in the processing unit in order to keep them at good positions.

### BRIEF SUMMARY OF THE INVENTION

However, if the intermediate transfer belt and cleaning unit are configured as one body, it is necessary to separate the intermediate transfer belt and cleaning unit within the main body of the apparatus, and remove the separated intermediate transfer belt from the main body of the apparatus when maintaining the intermediate transfer belt and cleaning unit. It is bad for workability and takes much time to separate the intermediate transfer belt and cleaning unit within the main body of the apparatus.

Further, after the maintenance of the intermediate transfer belt, it is necessary to insert the processing unit into the main body of the apparatus and connect the inserted intermediate transfer belt to the cleaning unit. This work takes much time and labor.

Maintenance of the cleaning unit requires similar work.

Accordingly, it is an object of the invention to provide an image forming apparatus which can simplify the work in maintenance of the intermediate transfer belt and cleaning unit.

According to an aspect of the invention, there is provided an image forming apparatus comprising:

a processing unit which is provided with an image holding unit and configured to be inserted into and removed from the main body of the apparatus; and

a cleaning unit which has a working part to come into contact with and clean the image holding unit, and a driving part to bring the working part into contact with and separate from the working part from the image holding unit,

wherein the working part of the cleaning unit is moved with the processing unit when the processing unit is inserted and removed; and

the driving part of the cleaning unit stays in the main body of the apparatus regardless of the movement of the processing unit, and engages with the working part when the processing unit is inserted, and separates from the working part when the processing unit is removed.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram showing the whole configuration of an embodiment of the invention;

FIG. 2 is a diagram showing a cleaning unit of the embodiment in a non-cleaning state;

FIG. 3 is a diagram showing an cleaning unit of the embodiment in a cleaning state;

FIG. 4 is a view showing the configuration of a processing unit and peripheral parts of the embodiment;

FIG. 5 is a view showing the configuration of a driving part of the cleaning unit of the embodiment;

FIG. 6 is a view showing the driving part of the cleaning unit of the embodiment in the state engaged with a holder;

FIG. 7 is a cam of the embodiment viewed diagonally from the upper side; and

FIG. 8 is a cam of the embodiment viewed diagonally from the lower side.

### DETAILED DESCRIPTION OF THE INVENTION

An embodiment of the invention will be explained hereinafter with reference to the accompanying drawings.

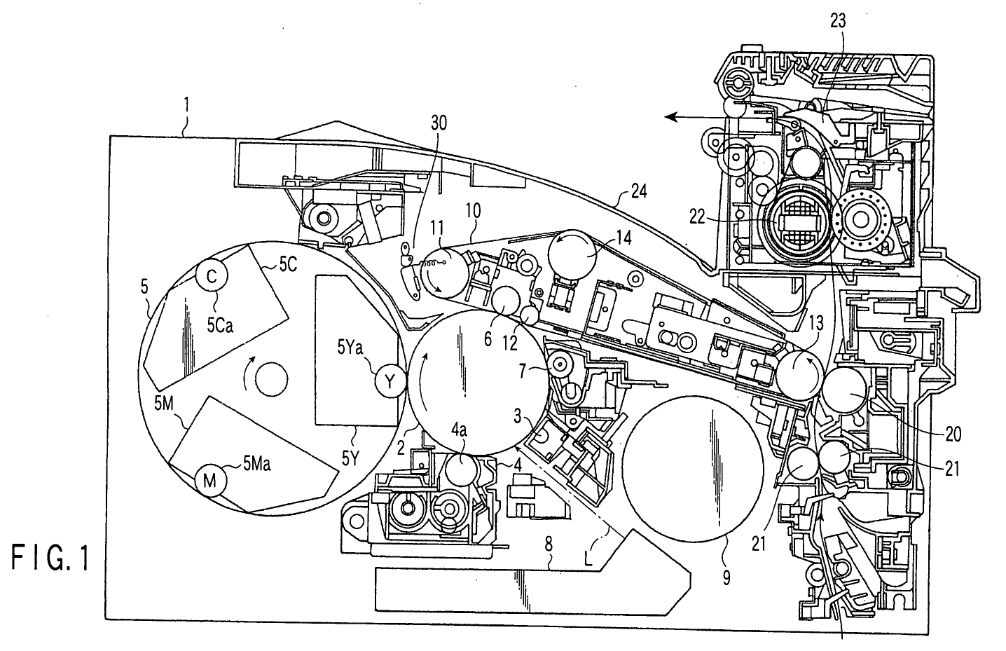

As shown in FIG. 1, an image forming apparatus such as a digital copier includes an image holding unit such as a photoconductive drum 2 provided rotatably in the clockwise direction in a main body 1. Around the photoconductive drum 2, a charging unit 3, a black color developing unit 4, a rotary color developing unit 5, a primary transfer roller 6, and a cleaning unit 7 are sequentially provided. The charging unit 3 charges the surface of the photoconductive drum 2.

A laser beam L emitted from a laser unit 8 is radiated to the surface of the photoconductive drum 2 through the clearance between the charging unit 3 and black color developing unit 4. The surface of the photoconductive drum 2 is exposed by the laser beam L, and an electrostatic latent image is formed on the surface of the photoconductive drum 2.

The black color developing unit 4 supplies black (K) toner to the surface of the photoconductive drum 2 through a roller 4a. By the supply of black toner, the electrostatic latent image on the photoconductive drum 2 is developed to a black visible image. A large-capacity black toner bottle 9 is prepared to supply the black toner to the black color developing unit 4.

The rotary color developing unit 5 has a yellow color developing part 5Y, a magenta color developing part 5M and a cyan color developing part 5C, and is rotated clockwise at the position close to the photoconductive drum 2 in the drawing. The yellow color developing part 5Y has a roller 5Ya separable from the surface of the photoconductive drum 2, and supplies yellow (Y) toner to the surface of the photoconductive drum 2, when the roller 5Ya comes into contact with the surface of the photoconductive drum 2. The magenta color developing part 5M has a roller 5Ma separable from the surface of the photoconductive drum 2, and supplies magenta (M) toner to the surface of the photoconductive drum 2, when the mug roller 5Ma comes into contact with the surface of the photoconductive drum 2. The cyan color developing part 5C has a roller 5Ca separable from the surface of the photoconductive drum 2, and supplies cyan (C) toner to the surface of the photoconductive drum 2, when the roller 5Ca comes into contact with the surface of the photoconductive drum 2.

The photoconductive drum 2 is rotated by one to several turns according to the number of necessary developing colors, and sequentially receives the toner of each color from the black color developing unit 4 and rotary color developing unit S. The electrostatic latent image on the photoconductive drum 2 is developed to a visible image of 1 to 4 overlaid colors.

The primary transfer roller 6 transfers the visible image on the photoconductive drum 2 to the intermediate transfer belt 10 that is an image holding unit passing in the clearance to the photoconductive drum 2. The cleaning unit 7 cleans the surface of the photoconductive drum 2 after the visible image is transferred. The toner remaining on the surface of the photoconductive drum 2 is removed by this cleaning.

The intermediate transfer belt 10 is wound and stretched around a drive roller 11, a wind roller 12, a driven roller 13 and a tension roller 14, and moved in the counterclockwise direction by the power received from the driving roller 11. The wind roller 12 acts to press the intermediate transfer belt 10 to the photoconductive drum 2. The tension roller 14 is provided to adjust the tension of the intermediate transfer belt 10.

A secondary transfer roller 20 is provided just like contacting the intermediate transfer belt 10 on the driven roller 13. A paper sheet supplied from a (not-shown) paper supply cassette to registration rollers 21 is fed to between the intermediate transfer belt 10 and secondary transfer roller 20 by the registration rollers 21. The visible image on the intermediate transfer belt 10 is transferred to the paper sheet by the secondary transfer roller 20. After the visible image is transferred, the paper sheet is fed to a fixing unit 22. The fixing unit 22 heats the visible image transferred to the paper sheet, and fixes the image to the paper sheet. The paper sheet passed through the fixing unit 22 is ejected to an ejected paper tray 24 at the top of the main body 1 through a guide gate 23. The secondary transfer roller 20 comes into contact with the intermediate transfer belt 10 on the driven roller 13 only when the transfer is necessary, and separates from the intermediate transfer belt 10 when the transfer is unnecessary.

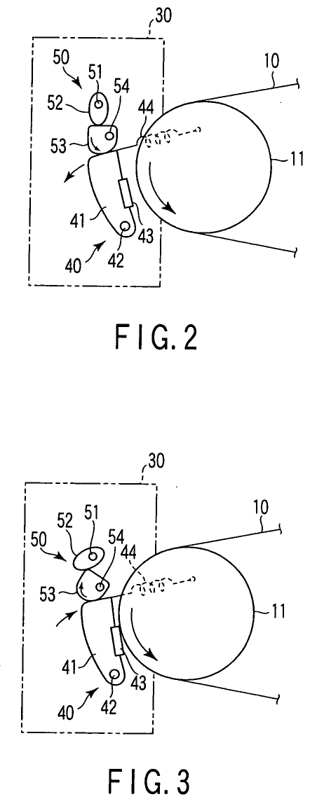

A cleaning unit 30 is provided in proximity to the driving roller 11. The cleaning unit 30 is provided with a cleaning member for the intermediate transfer belt 10, and rotatably held by the frame 101 of a processing unit 100 described later. The cleaning unit rotates to contact or separate from the intermediate transfer belt 10 on the driving roller 11, and cleans the intermediate transfer belt 10 while contacting the belt. The outline of the cleaning unit 30 is shown in FIG. 2 and FIG. 3. FIG. 2 shows the non-cleaning state, and FIG. 3 shows the cleaning state.

Namely, the cleaning unit 30 is composed of a working part 40 which comes in contact with and cleans the intermediate transfer belt 10, and a driving part 50 which brings the working part 40 into contact with and separates the working part from the image holding unit.

The working part 40 has a holder 41, a pivot 42 to support the lower part of the holder 41 rotatably, a blade 43 or a cleaning member held by the holder 41, and a spring 44 to give the holder 41 a deviating force acting on the intermediate transfer belt 10 so that the blade 43 comes into contact with the intermediate transfer belt 10. The holder 41 and blade 43 have a shape extending transversely in relation to the intermediate transfer belt 10, and have a length substantially equal to the width of the intermediate transfer belt 10. The blade 43 scrapes away and removes the material adhering to the intermediate transfer belt 10 while making contact with the belt.

The driving part 50 has a shaft 51 to transmit the torque of a motor 55 described later, a first eccentric cam 52 provided on the shaft 51, a second cam 53 interposed between the first cam 52 and the top of the holder 41, and a pivot 54 to pivotally hold the second cam 53.

The driving part 50 rotates the first cam 52 downward during the non-cleaning state as shown in FIG. 2. The first cam 52 is rotated downward to press the second cam 53. Then, the second cam 53 is rotated counterclockwise, the holder 41 is rotated in the direction opposite to the intermediate transfer belt 10, and the blade 43 is separated from the intermediate transfer belt 10. In this case, the first cam 52, second cam 53 and holder 41 are rotated against the deviating force of the spring 44.

The driving part 50 rotates the convex portion of the first cam 52 in the direction opposite to the intermediate transfer belt 10, and releases the pressure to the second cam 53 during cleaning, as shown in FIG. 3. When the pressure is released, the second cam 53 is rotated clockwise by the deviating force of the spring 44, the holder 41 is rotated in the direction of the intermediate transfer belt 10, and the blade is brought into contact with the intermediate transfer belt 10.

The cleaning by the cleaning unit 30 is performed after the one-color or multiple-color visible image transferred to the intermediate transfer belt 10 is transferred to a paper sheet.

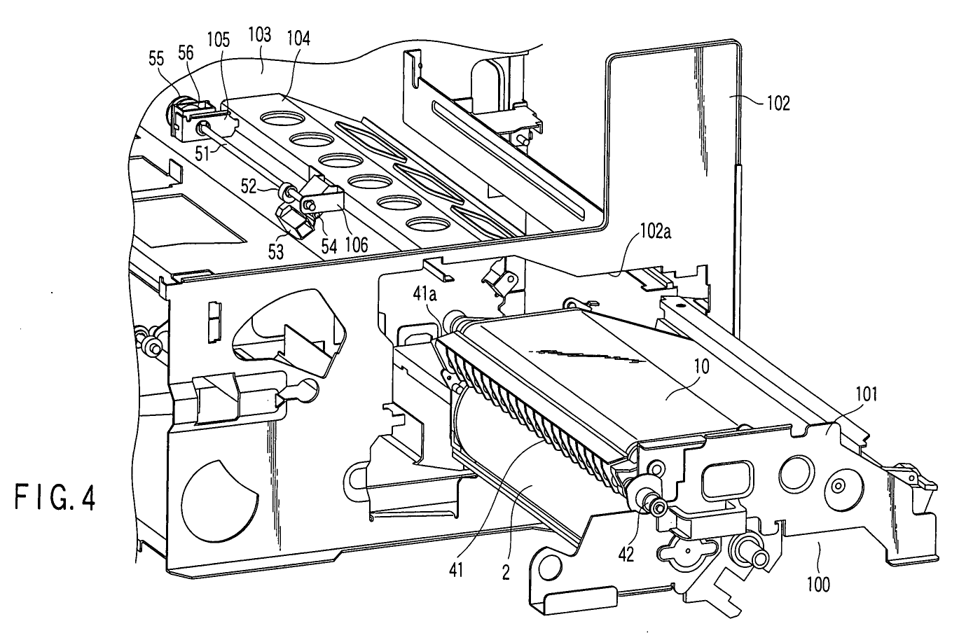

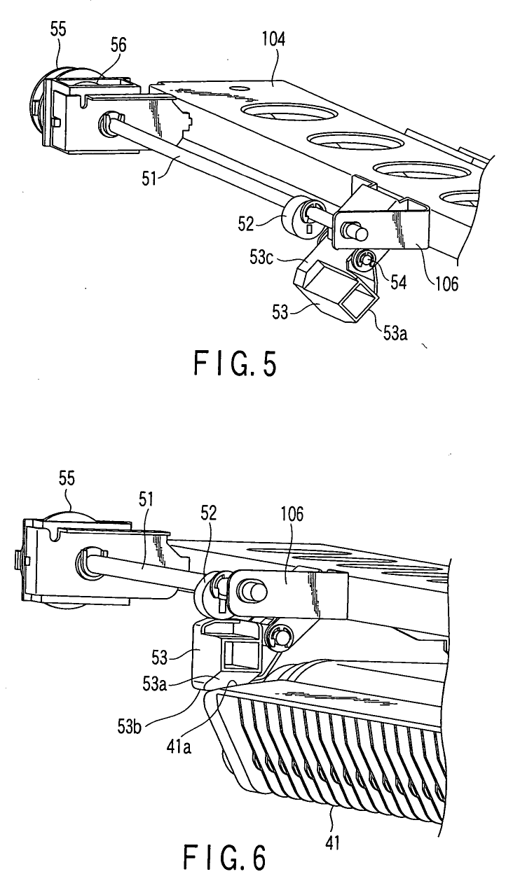

As shown in FIG. 4, the processing unit 100 is composed of a photoconductive drum 2, an intermediate transfer belt 10, rollers 11, 12, 13, 14, and a peripheral mechanism (including a frame 101 to hold the photoconductive drum 2 and rollers 11, 12, 13 and 14). The processing unit 100 can be inserted into and removed from the main body 1 along an attached rail, through an opening 102a formed in the front frame 102 of the main body 1.

The working part 40 shown in FIG. 2 and FIG. 3 is attached to the processing unit 100, and moved with the processing unit 100 when the processing unit 100 is inserted into or removed from the main body 1. The driving part 50 shown in FIG. 2 and FIG. 3 is a part separated from the processing unit 100, and stays in the main body 1 even if the process unit 100 is removed.

As shown in FIG. 4, a reinforcing member 104 is provided along the axial direction of the photoconductive drum 2, between the front frame 102 and the rear frame 103 of the main body 1. A bracket 105 is provided in the depth of the reinforcing member 104. A bracket 106 is provided also at substantially the middle of the reinforcing member 104. The shaft 51 is rotatably held between the brackets 105 and 106, just like along the axis of the photoconductive drum 2.

The bracket 105 is provided with a motor 55 and a clutch 56. The power of the motor 55 is transmitted to one end of the shaft 51 through the clutch 56. The first cam 52 is provided at the other end of the shaft 51 (close to the bracket 106), and rotated together with the shaft 51.

The bracket 106 is provided with the second cam 53 through the pivot 54. The second cam 53 is freely moved in the vertical direction centering on the pivot 54, and hangs down by its own weight and separates from the first cam 52, when the processing unit 100 is removed from the main body 1.

When the processing unit 100 is inserted into the main body 1, the lower oblique surface 53a of the second cam 53 which slides and comes into contact with the end portion of the holder 41 of the working part, shifts just like being pushed up, and is held between the first cam 52 and the top of the holder 41. An oblique surface 41a is formed also at the end portion of the longish side of the holder 41 in a part contacting the oblique surface 53a of the second cam 53. The second cam 53 is smoothly pushed up by the sliding contact of the oblique surfaces 53a and 41a. The oblique surface 41a is not limited to a plane. It may be a curved surface.

The second cam 53 has a first engaging surface 53b continued to the oblique surface 53a. When the processing unit 100 is completely inserted into the main body 1, the first engaging surface 53b comes into contact with substantially the center of the longish side of the top of the holder 41, and the second engaging surface 53c in the upper part of the second cam 53 comes into contact with the first cam 52.

In FIG. 6, the first cam 52 is in the downward rotated state. In this case, when the processing unit 100 is inserted into the main body 1, the holder 41 is pressed by the second cam 53 and rotated in the direction opposite to the intermediate transfer belt 10. Then, the blade 43 is separated from the intermediate transfer belt 10.

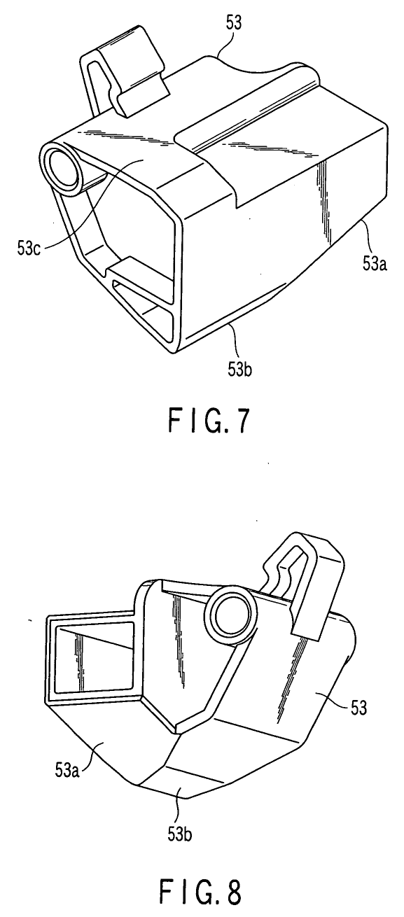

FIG. 7 shows the external view of the second cam 53 viewed diagonally from the upper side (from the engaging surface 53b). FIG. 8 shows the external view of the second cam 53 viewed diagonally from the lower side (from the engaging surface 53a).

As described above, the working part 40 of the cleaning unit 30 is configured to move with the processing unit 100 when the processing unit 100 is inserted and removed, and the driving part 50 of the cleaning unit 30 is configured to stay in the main body 1 regardless of the movement of the processing unit. Therefore, the work of separating the intermediate transfer belt 10 and cleaning unit within the main body 1 is unnecessary when maintaining the intermediate transfer belt 10. Separating the intermediate transfer belt 10 and cleaning unit within the main body 1 is also unnecessary when maintaining the cleaning unit 30.

Simply by inserting the processing unit 100 into the main body 1 after the end of maintenance, the working part 40 is automatically engaged with the driving part 50.

This remarkably simplifies the work in the maintenance of the intermediate transfer belt 10 and cleaning unit 30.

The working part 40 is made as one body with the intermediate transfer belt 10, and the positions of the blade 43 and intermediate transfer belt 10, and the pressure of the blade 43 to the intermediate transfer belt 10 can be maintained in appropriate states. Therefore, good cleaning performance can be always maintained.

The holder 41 is configured not to directly come into contact with the first cam 52 of the shaft 51, and the second cam 53 interposed between the first cam 52 and holder 41 is shifted vertically when the holder 41 is moved. Therefore, even if the first cam 52 is stopped at any rotated position due to a problem during printing, the processing unit 100 can be smoothly inserted into the main body 1.

If more the holder 41 only by the first cam 52, the first cam 52 must be made large. If a large first cam 52 is used, it is difficult to ensure a space to contain the first cam 52 in the main body 1. In this embodiment, the holder 41 is moved by interlocking two cams 52 and 53, and the first cam 52 does not need to be made large, and the blade 43 is surely brought into contact with and separated from the intermediate transfer belt 10.

The cleaning unit 30 is divided into the working part 40 and driving part 50, and the driving part 50 is separated from the processing unit 100. This can decrease the size of the processing unit 100. Therefore, the opening 102a to remove the processing unit 100 from the main body 1 can be made as small as possible. The minimized opening 102a can increase the intensity of the front frame 102.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming apparatus, comprising:
a processing unit which is provided with an image holding unit, and configured to be inserted and removed into/from the main body of the apparatus; and
a cleaning unit which has a working part to come into contact with and clean the image holding unit, and a driving part to bring the working part into contact with and separate from the image holding unit,
wherein the working part of the cleaning unit is moved with the processing unit when the processing unit is inserted and removed; and
the driving part of the cleaning unit stays in the main body of the apparatus regardless of the movement of the processing unit, and engages with the working part when the processing unit is inserted, and separates from the working part when the processing unit is removed.

2. The apparatus according to claim 1, wherein the working part of the cleaning unit has a blade which comes into contact with the image holding unit and scrapes away material adhered to the image holding unit, a holder which brings the blade into contact with the image holding unit by rotating in the direction of the image holding unit, and separates the blade from the image holding unit by rotating in the direction opposite to the image holding unit, and a spring which gives a deviating force to rotate the holder in the direction of the image holding unit, and
the driving part of the cleaning unit has a motor, a shaft to transmit the torque of the motor, a first cam provided on the shaft, and a second cam which slides and comes into contact with the holder, and is shifted and held between the holder and first cam when the processing unit is inserted into the main body of the apparatus.

3. The apparatus according to claim 2, wherein the driving part releases the pressure of the second cam to the holder by rotating the first cam in one direction, and rotates the holder in the direction of the image holding unit by the deviating force of the spring during cleaning, and presses the holder by the second cam by rotating the first cam in the other direction, and rotates the holder in the direction opposite to the image holding unit against the deviating force of the spring during non-cleaning.

4. The apparatus according to claim 2, further comprising a reinforcing member provided in the main body of the apparatus, and brackets provided in the reinforcing member to hold the shaft rotatably.

5. The apparatus according to claim 2, wherein the blade and holder are provided transversely with respect to the intermediate transfer belt, and are substantially as long as the intermediate transfer belt is wide, and
the second cam has an oblique surface at the end portion which slides and comes into contact with the holder when the processing unit is inserted into the main body of the apparatus.

6. The apparatus according to claim 5, wherein the second cam has a first engaging surface connected to the oblique surface in the lower part, and has a second engaging surface in the upper part,
the first engaging surface comes into contact with the top of the holder when the processing unit is completely inserted into the main body of the apparatus, and
the second engaging surface comes into contact with the first cam when the processing unit is completely inserted into the main body of the apparatus.

7. The apparatus according to claim 1, wherein the processing unit has a photoconductive drum and an intermediate transfer belt contacting the photoconductive drum as an image forming unit, and has a primary transfer roller to transfer a visible image on the photoconductive drum to the intermediate transfer belt, and rollers to move the intermediate transfer belt between the photoconductive drum and primary transfer roller.

8. The apparatus according to claim 7, further comprising:
a charging unit which charges the surface of the photoconductive drum;
a laser unit which emits a laser beam and exposes the surface of the photoconductive drum charged by the charging unit, and forms an electrostatic latent image on the surface of the photoconductive drum;
a black color developing unit which supplies black toner to the surface of the photoconductive drum, and develops the electrostatic latent image on the surface of the photoconductive drum to a black visible image;
a color developing unit which supplies color toners to the surface of the photoconductive drum, and develops the electrostatic latent image on the surface of the photoconductive drum to a color visible image;
a secondary transfer roller which comes into contact with the intermediate transfer belt, and transfers the visible image on the intermediate transfer belt to a paper sheet; and
a fixing unit which fixes the visible image transferred to the paper sheet by heating.

9. An image forming apparatus comprising:
a processing unit which is provided with an image holding unit, and configured to be inserted into and removed from the main body of the apparatus; and
a cleaning means which has a working part to come into contact with and clean the image holding unit, and a driving part to bring the working part into contact with and to separate the working part from the image holding unit,
wherein the working part of the cleaning means is moved with the processing unit when the processing unit is inserted and removed; and
the driving part of the cleaning means stays in the main body of the apparatus regardless of the movement of the processing unit, and engages with the working part when the processing unit is inserted, and separates from the working part when the processing unit is removed.

10. The apparatus according to claim 9, wherein the working part of the cleaning means has a blade which comes into contact with the image holding unit and scrapes away material adhered to the image holding unit, a holder which brings the blade into contact with the image holding unit by rotating in the direction of the image holding unit, and separates the blade from the image holding unit by rotating in the direction opposite to the image holding unit, and a spring which gives a deviating force to rotate the holder in the direction of the image holding unit, and
the driving part of the cleaning means has a motor, a shaft to transmit the torque of the motor, a first cam provided on the shaft, and a second cam which slides and comes into contact with the holder, and is shifted and held between the holder and first cam when the processing unit is inserted into the main body of the apparatus.

11. The apparatus according to claim 10, wherein the driving part releases the pressure of the second cam to the holder by rotating the first cam in one direction, and rotates the holder in the direction of the image holding unit by the deviating force of the spring during cleaning, and presses the holder by the second cam by rotating the first cam in the other direction, and rotates the holder in the direction opposite to the image holding unit against the deviating force of the spring during non-cleaning.

12. The apparatus according to claim 10, further comprising a reinforcing member provided in the main body of the apparatus, and brackets provided in the reinforcing member to hold the shaft rotatably.

13. The apparatus according to claim 10, wherein the blade and holder are provided transversely with respect to the intermediate transfer belt, and are substantially as long as the intermediate transfer belt is wide, and
the second cam has an oblique surface at the end portion which slides and comes into contact with the holder when the processing unit is inserted into the main body of the apparatus.

14. The apparatus according to claim 13, wherein the second cam has a first engaging surface connected to the oblique surface in the lower part, and has a second engaging surface in the upper part,
the first engaging surface comes into contact with the top of the holder when the processing unit is completely inserted into the main body of the apparatus, and
the second engaging surface comes into contact with the first cam when the processing unit is completely inserted into the main body of the apparatus.

15. The apparatus according to claim 9, wherein the processing unit has a photoconductive drum and an intermediate transfer belt contacting the photoconductive drum as an image forming unit, and has a primary transfer roller to transfer a visible image on the photoconductive drum to the intermediate transfer belt, and rollers to move the intermediate transfer belt between the photoconductive drum and primary transfer roller.

16. The apparatus according to claim 15, further comprising:
a charging means which charges the surface of the photoconductive drum;
a laser means which emits a laser beam and exposes the surface of the photoconductive drum charged by the charging unit, and forms an electrostatic latent image on the surface of the photoconductive drum;
a black color developing means which supplies black toner to the surface of the photoconductive drum, and develops the electrostatic latent image on the surface of the photoconductive drum to a black visible image;
a color developing means which supplies color toners to the surface of the photoconductive drum, and develops the electrostatic latent image on the surface of the photoconductive drum to a color visible image;
a secondary transfer means which comes into contact with the intermediate transfer belt, and transfers the visible image on the intermediate transfer belt to a paper sheet; and
a fixing means which fixes the visible image transferred to the paper sheet by heating.

17. A processing unit comprising:
a photoconductive drum:
an intermediate transfer belt to come into contact with the surface of the photoconductive drum;
rollers to rotate the intermediate transfer belt;
a frame to support the photoconductive drum and rollers; and
a cleaning unit to clean the intermediate transfer belt,
wherein the cleaning unit has a blade which comes into contact with the intermediate belt, and eliminates material adhered to the intermediate transfer belt; a holder which is rotatably provided in the frame, and rotated in the direction of the intermediate transfer belt to bring the blade into contact with the intermediate transfer belt during cleaning, and rotated in the direction opposite to the intermediate transfer belt to separate the blade from the intermediate transfer belt during non-cleaning; and a spring which gives a deviating force to rotate the holder in the direction of the intermediate transfer belt.

18. The unit according to claim 17, wherein the blade and holder are provided transversely with respect to the intermediate transfer belt, and are substantially as long as the intermediate transfer belt is wide.
